(19) United States
(12) Patent Application Publication
(10) Pub. No.: US 2023/0097978 A1
(43) Pub. Date: Mar. 30, 2023

(54) PROTECTING MEMBER FOR A BATTERY STRUCTURE OF AN ELECTRIC VEHICLE

(71) Applicant: Mubea Carbo Tech GmbH, Salzburg (AT)

(72) Inventor: Christoph Renner, Gosau (AT)

(21) Appl. No.: 17/910,054

(22) PCT Filed: Mar. 9, 2021
(86) PCT No.: PCT/EP2021/055907

§ 371 Date: Sep. 8, 2022

(30) Foreign Application Priority Data
Mar. 19, 2020 (CH) 00335/20

(51) Int. Cl. B60K 1/04

(52) U.S. Cl. CPC B60K 1/04; B60K 2001/0438

(57) ABSTRACT

The invention relates to a protecting member for a battery structure of an electric vehicle. The protecting member includes a top belt, a bottom belt and a core arranged between and interconnecting the top belt and the bottom belt. The core is at least partially made from a porous and fibrous structural material, such as plywood.

### FIELD OF THE INVENTION

The present invention relates to a protecting member for a battery structure for an electric vehicle including a hybrid vehicle, a battery structure comprising such a protecting member, and a method for producing the protecting member for a battery structure.

### BACKGROUND OF THE INVENTION

DE102015101096A1 was first published in July 2016 in the name of Porsche AG. It relates to a battery carrying structure. The battery facilities includes an underbody battery between a bottom plate and a floor. At least one deformation zone is fore-seen to avoid unwanted damage to the underbody battery. The deformation zone comprises a plurality of deformation elements arranged above the bottom plate and below the underbody battery, such that the bottom plate can deform upwards without damaging the battery facilities. The deformation elements can be hollow profiles extending in x-direction along the length of the vehicle.

WO2015/077000A1 was first published in May 2015 in the name of Atieva Inc. It relates to a battery pack protection system for use with an electric vehicle, in which the battery pack is mounted under the car. The system utilizes a plurality of deformable cooling conduits located between the lower surface of each of the batteries and the lower battery pack enclosure panel. A thermal insulator is interposed between the conduits and the lower enclosure panel. A layer of thermally conductive material may be included which is interposed between the cooling conduits and the thermal insulator and in contact with a lower surface of each of the cooling conduits. The cooling conduits are configured to deform and absorb impact energy when an object, such as road debris, strikes the lower surface of the lower battery pack enclosure panel. The deformable cooling conduits may be fabricated from a plastic polymer material, such as polyethylene or polypropylene, and the lower battery pack enclosure panel may be fabricated from a metal, such aluminum or steel. Further protection may be achieved by positioning a ballistic shield, alone or with a layer of compressible material, under the bottom surface of the battery pack. The ballistic shield may be fabricated from either a metal or high density plastic, and the layer of compressible material may be made from an open-cell or closed-cell foam of silicone or urethane and be interposed between the battery pack and the ballistic shield.

FR2977554A1 was first published in January 2013 in the name of Fior Concept. It relates to a vehicle having a frame which comprises a honeycomb shaped structure that forms a plate. A surface of an upper plate is rigidly connected to an upper surface of the plate. A surface of a bottom plate is rigidly connected to a lower surface of the plate. Resistant structures are protruded above a wheel notch and attached with the notch by a complete and rigid connection. An external resistant belt is attached to an external circumference of the plate by a complete and rigid connection and is placed partially between the structures of passages of the wheels. The plate, upper plate and lower plate are made from light metal alloy material, e.g. based on aluminum.

WO2012/076308A1 was first published in June 2012 in the name of BCOMP GmbH. It relates to stiffened thin-walled natural plant fibre composite products comprising: first plant fibre yarns having a smaller thickness and second stiffening plant fibre yarns having a larger thickness, wherein at least one side of the composite product is even. The first and second plant fibre yarns are arranged or woven in the same or adjacent fibre layers and are resin-impregnated in matrix material in a molding process to form the composite product. Additional natural fibre layers can be arranged on the surface of the composite product to form meso-scale ribs to improve the structural efficiency of the natural fibre composite parts. The first and second type of fibre are selected among: flax, hemp, jute, ramie, kenaf, sisal, henequen, bamboo, silk, cotton, or may also comprise a non-natural type of fibre, such as carbon fibre or glass fibre. Applications include composite parts for bicycles, sports equipment and cars.

DE102015108573A1 was first published in December 2016 in the name of BCOMP GmbH. It discloses a production process and production device for producing stiffened thin-walled fibre composite elements having reinforcing surface ribs.

The composite elements are formed by arranging a mesh-like array of reinforcing fibre yarns on a front surface of a base layer and impregnating both the fibre yarns and the base layer from the front surface side with matrix material. A novel impregnation process is used to minimize the amount of matrix material in such a manner, that the reinforcing fibre yarns are not fully covered with matrix material and interstices between the fibre yarns remain matrix-free. Thus the fibre yarns form surface ribs that provide the obtained composite elements with an unevenly structured front surface providing enhanced stiffness. The fibre yarn is made from natural fibre. The base layer can be made from carbon fibre, glass fibre, natural fibre, metal, polymer, wood veneer or a combination thereof. However, for automotive or aerospace applications the base layer shall be made from sheet metal such as aluminum sheet.

WO2013/026925A1 was first published in February 2013 in the name of BCOMP GmbH. It relates to a method for manufacturing a composite material, comprising: stacking layers of foam or wood with layers of natural fibre-based composite; bonding the layers; obtaining a plurality of structured parts by cutting the obtained stack perpendicular to the layer planes, whereas the thickness of said parts is between 1 mm and several dm.

WO2019/087141A1 was first published in May 2019 in the name of BCOMP GmbH. It relates to a foil- or band-like composite product comprising a lattice of crisscrossed fibre threads defining mesh openings and being impregnated with polymer and laminated on a supporting flexible mat. The threads are impregnated with the polymer in an asymmetric manner, such that the upper portion of the thread comprises a higher quantity of impregnated polymer than the lower and median part. The fibres can be selected from plant fibres, such as flax, cellulose, hemp, kenaf, nettle, jute, abaca, sisal, bambou, cotton, or can be synthetic fibres, such as polymer fibres, carbon fibres, glass fibres, basalt fibres, aramid fibres, or can be animal fibres, such as silk or wool. The invention also relates to a method and device for producing the composite product.

The prior art protection systems for underfloor battery packs usually require relatively large deformation paths for absorbing the occurring energy. Therefore, the known protection systems require a significant amount of space between the bottom of the vehicle and the parts to be protected to fulfill the safety requirements, i.e. depletion of the introduced energy without significant introduction of forces into the parts to be protected. Depending on the type of vehicle this can have a significant impact on at least one of the following parameters: Ground clearance, access height, head clearance, vehicle height, cross-sectional area.

The battery protection systems known from the prior art are usually made from metal or composite material and are less appropriate for absorbing high punctual impact loads, or they require an additional ballistic shield for this purpose. Their construction involves multiple parts that must be assembled together and thus add complexity to the car manufacturing process.

WO2018/149762A1 was first published in August 2018 in the name of present applicant MUBEA CARBO TECH GmbH. It relates to a battery structure having a protector with a core arranged between a wave-shaped top belt and a bottom belt.

### SUMMARY OF THE INVENTION

Therefore, it is an object of the invention to provide an improved protection system for a battery structure of an electric (including hybrid) vehicle, which is comparably light-weight, needs less space in height direction to absorb impact energy, is easy to manufacture and easy to be mounted in the vehicle. A further aspect of the invention is directed to an improved protection system, which is less expensive in manufacturing.

These objects are achieved by a protecting member for a battery structure e.g. of an electric vehicle, the protecting member comprising a top belt, a bottom belt and a core arranged between and interconnecting the top belt and the bottom belt, wherein the core is at least partially made from a porous and fibrous structural material.

Such a protecting member has various advantages over known systems. The porosity of the structural material assures the light-weightiness of the protecting member. The fibrous structure provides high-performance of the mechanical properties of the core of the protecting member, which includes: good plastic or irreversible deformation and fracture behaviour to absorb impact energy, e.g. when a larger object, such as a retractable bollard, strikes the lower surface of the battery structure; good intrusion protection behaviour to absorb high punctual loads, e.g. when smaller objects, such as road debris, try to penetrate the protecting member.

Compared to known protection systems having compressible structures or materials and ballistic shields, the protecting member of the invention has a simpler construction and is yet efficient in absorption of impact energy.

In this application, the term porous or porosity shall preferably be directed to porous materials that have pores distributed over the volume of the core with a certain pore density distribution, in which the pore density may vary within certain boundaries. As well, the term fibrous or fiber structure shall preferably be directed to materials that contain fibers distributed over the volume of the core with a certain fiber density distribution, in which the fiber density may vary within certain boundaries. In particular, the pores shall be present in a mixture with the fibers in such a way that both light-weightiness and structural stability are achieved. However, the terms porous or porosity and the terms fibrous or fiber structure shall preferably not encompass materials that have only single pores or single fibers, nor that have pores or fibers only in sub-sections of the core, nor that have zones of pores and zones of fibers segregated from one another. Very good results can be achieved by the intermingled co-existence of pores and fibers of sufficient density.

The protecting member is particularly suitable for protecting underfloor battery structures in electric (including hybrid) vehicles. However, the protecting member of the invention is also suitable for other applications which are herewith also encompassed, such as lightweight structural elements for reinforcement and absorption of impact energy in automotive or aerospace applications. The following embodiments include modifications, improvements and/or variations of the protecting member according to the present invention.

In embodiments, the porous and fibrous structural material contains or is a naturally grown fiber composite material. Thus, the porous and fibrous structural material not only contains or consists of organic material, but is a naturally occurring or organically grown fiber composite structure. Thereby, complicated material processing to produce artificial fiber composite materials are avoided.

In embodiments, the porous and fibrous structural material contains or consists of cellulose fibers embedded in a matrix of lignin. This includes all sorts of grown wood material found in stems and roots of trees or shrubs or other woody plants.

In embodiments, the porous and fibrous structural material is plywood that contains a stack of several layers of wood veneer. Plywood has besides all the above-mentioned also further advantages, such as: ease of manufacturing, ease of machining, availability in large quantities and at low cost. In alternative embodiments, the porous and fibrous structural material can also be solid wood. Cores made from porous and fibrous structural wood, such as plywood or solid wood, also have other advantages, such as: high elasticity and good damping behaviour, e.g. in case of road bumps and vehicle vibrations; high thermal isolation properties; high thermal capacity; good electric insulation; treatability to impart flame retardance; etc.

In embodiments of plywood, the layers of wood veneer are glued together with adjacent layers having their fibers or wood grains rotated relative to one another. Herein typically, the fibers in each layer have a preferential orientation along a pre-dominant longitudinal fiber direction. In preferred embodiments of plywood, the number of stack layers can e.g. be chosen to be uneven, and/or the rotation angle between adjacent layers can e.g. be about 90° or about 45°.

Exemplary types of wood types suitable for the wooden core in the protecting member are: balsa wood, birch wood, beech wood, poplar. Other wood types are also possible.

In embodiments, the core is shaped as a base plate having a planar upper surface and a planar lower surface. Such a planar core, typically with largely planar top belt and bottom belt, further simplifies manufacturing and still provides the favourable features of a flexible core with stiffer top belt and bottom belt.

In alternative embodiments, the core is shaped as a base plate having an upper side with at least one beam being mounted thereon, in particular glued with an adhesive, such that the core is provided with a wave-like reinforcement structure. Herein, the wave-like structure is visible in a vertical cross section, i.e. in a cross sectional plane extending along a vertical or height direction z of the protecting member or, in mounted state, of the electric vehicle. The wave-like shape of the core also serves for distancing the protecting member (in areas outside of the beams) from a lower side of the battery structure for providing deformation space, into which the protecting member can expand in case of an impact event without damaging the battery structure. The at least one beam also provides mechanical enforcement for placing fastening means, such as screws, for fastening the protecting member underneath the underfloor battery structure.

In embodiments, the base plate and the at least one beam are manufactured from the same or at least structurally similar or a different fibrous and porous structural material, in particular plywood of the same type or as a modification plywood of another type. In embodiments, the base plate can at least partially or completely be made from a heavier material, in particular heavier wood material in the form of plywood or possibly solid wood, such as e.g. beech wood; and the at least one beam can at least partially or completely be made from a lighter material, in particular lighter wood material in the form of plywood or possibly solid wood, such as e.g. birch wood. The heavier material or material having a higher Young's modulus provides higher stiffness to the base plate, whereas the lighter material or material having a lower Young's modulus provides the beam with more flexibility for energy absorption.

As an alternative or in combination, the at least one beam can at least partially or completely be made from a foam material, in particular a polymeric foam material, such as e.g. polyurethane foam (PU foam), polyethylene terephthalate foam (PET foam), or other. Foam materials can be beneficial for energy absorption.

In embodiments, the top belt has a wave-like shape that has an at least partial or complete form-locking fit with the wave-like reinforcement structure of the core. As an alternative, the top belt has at least a wave-like shape resembling the wave-like reinforcement structure of the core and supporting it at least in several joining areas. The wave-like shape of the protecting member, or at least its upper part, offers an optimized distribution of the impact energy into the protecting member by a combination of elastic and/or plastic deformation and thereby further improves its capability to absorb impact energy. In principle, the wave-like shape can extend in two directions, if appropriate.

In embodiments, at least two beams are arranged parallel to one another and/or parallel to an edge of the protecting member. The protecting member can in principle have any shape or contour. For example, two or more beams can be arranged parallel to a transverse (y) edge of the protecting member, which is suitable or designed for being mounted parallel to a transverse (y) extension of the electric vehicle. As an alternative or in addition, one or more beams can also be arranged parallel to a longitudinal (x) edge of the protecting member, which is suitable or designed for being mounted parallel to a length extension (x) of the electric vehicle.

In embodiments, the at least one beam comprises several beams that form a frame, e.g. a rectangular frame, for the base plate; in particular, an open or closed frame that runs along or close to some or all edges of the base plate. In embodiments, the at least one beam is or comprises at least one cross beam that runs across the base plate under an angle relative to edges of the base plate. Embodiments also encompass arbitrary combinations of: cross beam(s), beams running in a frame-like manner, beam(s) running along or close to edge(s). The disclosed beam arrangements can provide favourable reinforcement structures to the base plate of the core.

In embodiments, a bore hole for mounting the protecting member to the battery structure of the electric vehicle is machined through the at least one beam. Preferably, the bore hole is machined, e.g. drilled or milled, along the vertical or height direction (z) of the protecting member or electric vehicle.

In embodiments, the top belt and/or the bottom belt is or are at least partially or completely made from a material selected from the group consisting of: glass-fiber reinforced plastic (GFK); carbon-fiber reinforced plastic (CFK); basalt-fiber reinforced polymer composites; aramid-fiber reinforced polymer composites: metal, such as sheet metal or deep-drawn sheet metal, e.g. sheet aluminum; natural-fiber reinforced polymer composites; and combinations thereof. This material choice gives very high stiffness to the top and bottom belt, which in combination with the flexibility of the core provides excellent energy absorption and damage behaviour of the protection member in all types of high impact events.

As an alternative or in addition, the top belt and/or the bottom belt is or are at least partially or completely made from a material containing natural fibers, in particular fibers selected from the group consisting of: flax, hemp, jute, ramie, kenaf, sisal, henequen, bamboo, silk, cotton, and combinations thereof.

In embodiments, the top belt and the bottom belt are directly joined together in edge areas that laterally protrude over the core and/or in areas of mounting holes in the protecting member. The direct joining of the top belt with the bottom belt allows for rigid mounting with high force transmission of the protecting member to the battery structure, such that the deformable zone between the protecting member and the battery structure can be maintained also during high impact events. In other embodiments, the areas of mounting holes can still contain the core with a non-vanishing local thickness and with a sleeve, e.g. metal sleeve or aluminum sleeve, being inserted for receiving the mounting means, such as a screw.

In embodiments, the top belt and the bottom belt form an elevation in those edge areas that laterally protrude over the core. This also allows to provide the distance between the protecting member and the battery structure required for the deformable zone in a simple and efficient manner.

In embodiments, the top belt and/or the bottom belt each has a thickness of less than 1.5 mm or equal to 1 mm; and/or the core has a first core thickness of less than 10 mm in the area of the base plate and a second core thickness of less than 30 mm in an area where a or the reinforcing beam is mounted.

In embodiments, the core has wedge-shaped edges at which the core is tapered off. This allows to homogenize the force transmission between the top and bottom belts and the core and to improve the flexural behaviour of the core and thus of the protecting member as a whole.

In a second aspect, the invention relates to a battery structure of an electric vehicle, wherein the battery structure comprises a protecting member as disclosed herein.

In a third aspect, the invention relates to a method for producing a protecting member, in particular a protecting member as disclosed herein and providing the above-mentioned advantages, for a battery structure of an electric vehicle, the method comprising the steps of:
a. providing a core at least partially made from a porous and fibrous structural material, in particular plywood,
b. joining the core on its lower surface with a bottom belt, in particular by gluing with an adhesive, and
c. joining the core on its upper surface with a top belt, in particular by gluing with an adhesive.

Embodiments of the production method comprise the steps of:
d. machining the core to obtain a desired shape of the core, and
e. inserting the core in an at least partially or completely positive-locking manner between the top belt and the bottom belt such that the protecting member is formed as a monolithic cavity-free component.

This differs from known protection systems in that no hollow elements or hollow volumes for providing deformable zones, cooling channels or the like are present inside the protecting member itself.

In embodiments, the method step d. of machining includes three-dimensional milling (3D-milling) of the core to form tapered-off edges of the core.

Embodiments of the production method further comprise, preferably after step a. and before steps b. and c., the steps of:
f. manufacturing the core to include a base plate and at least one reinforcement beam, which is mounted onto an upper surface of the base plate (e.g. by stacking and gluing with an adhesive), preferably with its length extension parallel to an edge of the protecting member.

In embodiments, the method steps d. and f. also include the sequence of steps of: machining core parts, such as base plate and beam(s), to a desired shape; then manufacturing the core by mounting or stacking and gluing the core parts together; and then further machining the core to the desired shape.

Embodiments of the production method further comprise, preferably after step f., a further step of machining, e.g. milling or drilling, a hole through the core in an area of the beam, i.e. through the base plate and the beam, in a vertical direction (z) of the protecting member for mounting the protecting member to the battery structure of the electric vehicle.

It is to be understood that both the foregoing general description and the following detailed description present embodiments with optional features, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described invention will be more fully understood from the detailed description given herein below and the accompanying drawings which should not be considered limiting to the invention described in the appended claims. The drawings are showing in:

FIG. 1 a perspective top view of a protecting member of the invention;

FIG. 2 a partly cross-sectional detail view F from FIG. 1;

FIG. 3 a partly cross-sectional detail view G from FIG. 2 showing an edge region of the core of the protecting member;

FIG. 4 an exploded view of the layered construction of the protecting member;

FIG. 5 an exploded detail view D of FIG. 4 showing a core detail; and

FIG. 6 a partly cross-sectional detail view E of FIG. 4 showing another core detail.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as being limited to the embodiments set forth herein; rather, these embodiments are provided so that this disclosure will satisfy applicable legal requirements. Whenever possible, like reference numbers will be used to refer to like components or parts.

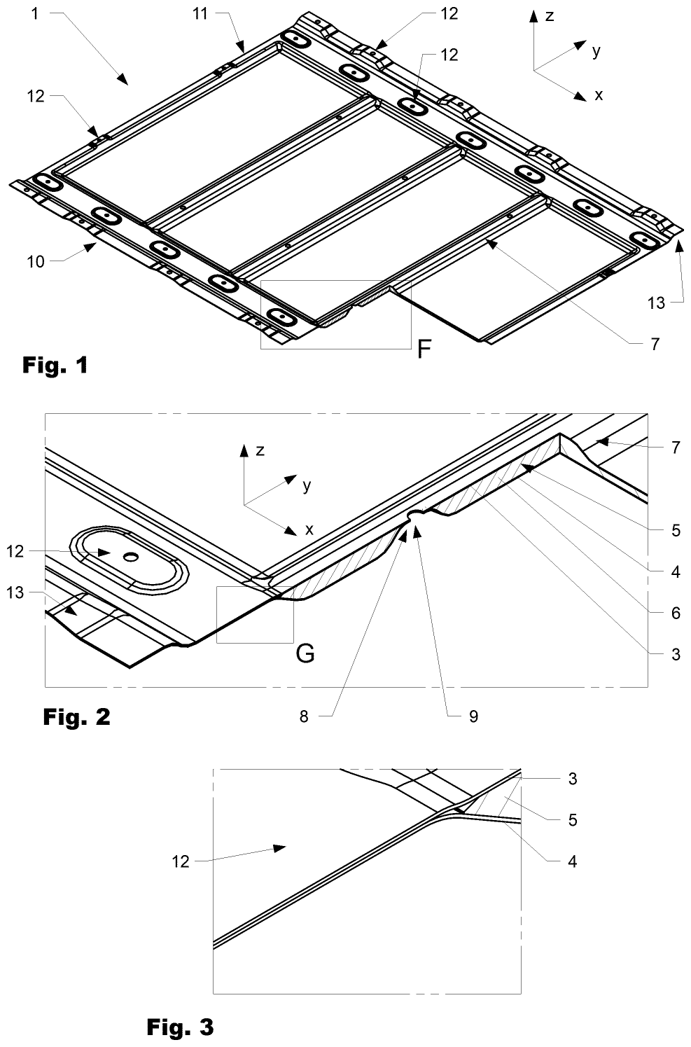

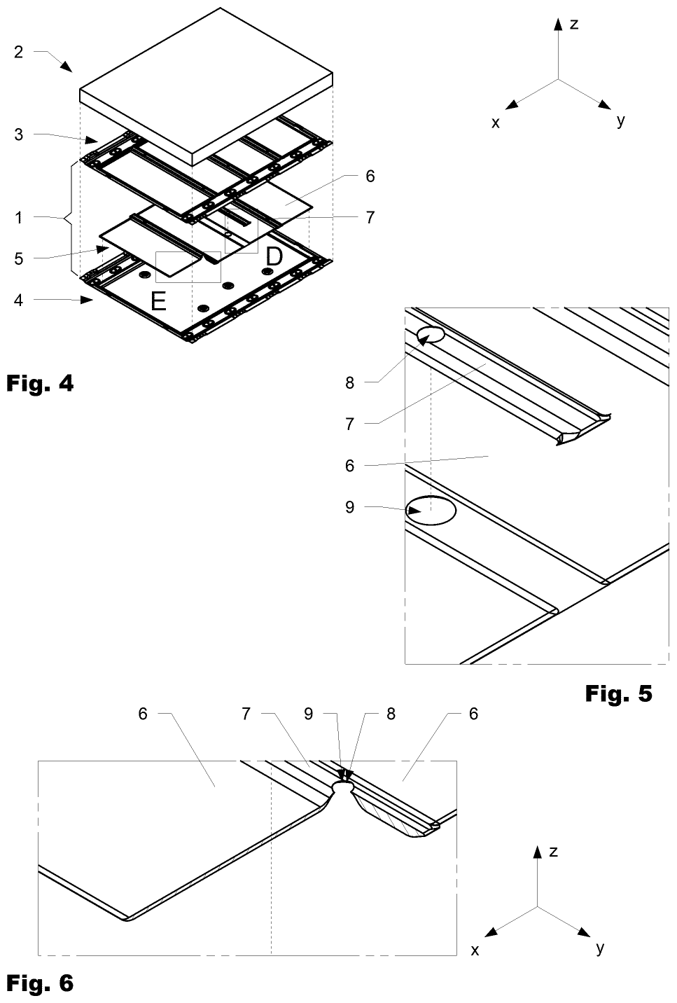

FIG. 1 shows a perspective top view of a protecting member 1 according to the invention, which is suitable for protecting an underfloor battery structure 2 of an electric vehicle. In the embodiment shown, the protecting member 1 has an essentially planar-like extension with an essentially rectangular contour for fitting with a bottom of a battery structure 2 (schematically shown in FIG. 4) of an underbody battery structure of an electric vehicle. Depending on the field of application, other shapes or contours of the protecting member 1 are possible and may be used. For example, the protecting member 1 can have a shape or contour adapted to a T-shape battery structure, as may be present in electric sports cars.

The exemplary protecting member 1 shown in FIG. 1 has longitudinal edges 10 in x-direction and transverse edges 11 in y-direction. In a mounted state of the protecting member 1, the x-direction corresponds to a length extension and the y-direction to a transverse extension of the electric vehicle. The edges 10, 11 are equipped with mounting structures 12 and also wing-shaped edges 13 for mounting the protecting member 1 to the battery structure 2 or to the underbody of the electric vehicle. As shown, the protecting member 1 has a wave-like shape or at least wave-like upper part. This improves the dissipation of impact energy by combined elastic and/or plastic deformation. However, the protecting member 1 can also be flat or substantially flat, i.e. flat at least in an inner region, e.g. by omitting the transverse beams 7. This simplifies the manufacturing process while maintaining good elastic and deformation behaviour of the protecting member 1.

FIG. 2 shows a partly cross-sectional detail view F from FIG. 1 disclosing the layered construction of the protecting member 1. A core 5 is sandwiched between and preferably firmly joined with a top belt 3 and a bottom belt 4. The core 5 includes a base plate 6, which is largely planar, and a beam 7, which is largely elongated. In the region of the transverse beam 7, a mounting hole 8, 9 is machined, e.g. drilled, through the base plate 6 and the beam 7. In the region of the mounting hole 8, 9 the core thickness is reduced to zero and the top belt 3 and the bottom belt 4 are directly joined together. This allows to mount the protecting member 1 rigidly to the battery structure 2. The beams 7 also provide the wave-like shape of the protecting member 1 and the required distance between the protecting member 1 and the battery structure 2 for creating the deformation space or deformable zone in case of high impace events causing elastic or inelastic, i.e. damaging, deformation of the protecting member 1.

FIG. 3 shows detail G from FIG. 2 in cross section, showing an edge region of the core 5. There, the core 5 has a wedge-shaped edge, at which the core 5 is tapered off. In particular, in the edge region of the core 5, the bottom belt 4 is curved upwards towards the flat top belt 3 and the intermediate core thickness is continuously reduced to zero (when viewing from the center towards the edge are of the protecting member 1), such that the bottom belt 4 and the top belt 3 are joined together.

FIG. 4 shows in exploded view the battery structure 2, the top belt 3, the core 5 with base plate 6 and beams 7, and the bottom belt 4. FIG. 5 shows in detail view D and FIG. 6 in detail view E the mounting hole 8 in the beam 7 and the mounting hole 9 in the base plate 6.

The invention also relates to a battery structure 2 of an electric vehicle, the battery structure 2 comprising a protecting member 1 as disclosed herein. The invention also relates to a method for producing the protecting member 1 as disclosed herein.

Throughout this application, the term “electric vehicle” (EV) also includes hybrid vehicles, such as plug-in hybrid vehicles (PHEV) and in general all vehicles requiring an underbody battery structure 2 which needs or benefits from a protecting member 1 as disclosed herein.

### LIST OF DESIGNATIONS

1 Protecting member
2 Battery structure
3 Top belt
4 Bottom belt
5 Core, plywood core
6 Base plate
7 Beam, transverse beam, cross beam
8 Mounting hole in beam, sink hole
9 Mounting hole in base plate, sink hole
10 Longitudinal edge (in x-direction) of protecting member
11 Transverse edge (in y-direction) of protecting member
12 Mounting structures
13 Wing-shaped edge structure
x longitudinal direction of protecting member or electric vehicle
y transverse direction of protecting member or electric vehicle
z vertical or height direction of protecting member or electric vehicle

1. Protecting member for a battery structure of an electric vehicle, the protecting member comprising:
a. a top belt;
b. a bottom belt; and
c. a core arranged between and interconnecting the top belt, and the bottom belt, wherein
d. the core is at least partially made from a porous and fibrous structural material.

2. The protecting member according to claim 1, wherein the porous and fibrous structural material contains or is a naturally grown fiber composite material.

3. The protecting member according to claim 1, wherein the porous and fibrous structural material contains or consists of cellulose fibers embedded in a matrix of lignin.

4. The protecting member according to claim 1, wherein the porous and fibrous structural material is plywood that contains a stack of several layers of wood veneer.

5. The protecting member according to claim 1, wherein the core is shaped as a base plate having a planar upper surface and a planar lower surface.

6. The protecting member according to claim 1, wherein the core is shaped as a base plate having an upper side with at least one beam mounted thereon, in particular glued with an adhesive, such that the core provided with a wave-like reinforcement structure.

7. The protecting member according to claim 6, wherein the base plate and the at least one beam are manufactured from the same or a different fibrous and porous structural material, in particular plywood.

8. The protecting member according to claim 6, wherein the base plate is at least partially or completely made from a heavier material, in particular beech wood; and the at least one beam is at least partially or completely made from a lighter material, in particular birch wood.

9. The protecting member according to claim 6, wherein the at least one beam is at least partially or completely made from a foam material, in particular a polymeric foam material, such as e.g. poly-urethane foam (PU foam) or polyethylene terephthalate foam (PET foam).

10. The protecting member according to claim 6, wherein the top belt has a wave-like shape that has a form-locking fit with the wave-like reinforcement structure of the core.

11. The protecting member according to claim 6, wherein at least two beams are arranged parallel to one another and/or parallel to an edge of the protecting member and/or are arranged in a frame-like manner and/or comprise a cross bar.

12. The protecting member according to claim 6, wherein a bore hole for mounting the protecting member to the battery structure of the electric vehicle is machined through the at least one beam.

13. The protecting member according to claim 1, wherein the top belt and/or the bottom belt is or are at least partially made from a material selected from the group consisting of: glass-fiber reinforced plastic (GFK); carbon-fiber reinforced plastic (CFK); basalt-fiber reinforced polymer composites; aramid-fiber reinforced polymer composites; metal, such as sheet metal; natural-fiber reinforced polymer composites; and combinations thereof.

14. The protecting member according to claim 1, wherein the top belt and the bottom belt are directly joined together in edge areas that laterally protrude over the core and/or in areas of mounting holes in the protecting member.

15. The protecting member according to claim 1, wherein the top belt the bottom belt form an elevation in edge areas that laterally protrude over the core.

16. The protecting member according to claim 1, wherein the top belt and/or the bottom belt each has a thickness of less than 1.5 mm or equal to 1 mm; and/or the core has a first core thickness of less than 10 mm in the area of the base plate and a second core thickness of less than 30 mm in an area where a or the reinforcing beam is mounted.

17. The protecting member according to claim 1, wherein the core has wedge-shaped edges at which the core is tapered off.

18. A battery structure of an electric vehicle, the battery structure comprising a protecting member according to claim 1.

19. A method for producing a protecting member according to claim 1, for a battery structure of an electric vehicle, the method comprising the steps of:
a. providing the core at least partially made from the porous and fibrous structural material comprising plywood;
b. joining a lower surface of the core with a bottom belt, by gluing with an adhesive; and
c. joining an upper surface of the core with the top belt, by gluing with an adhesive.

20. The method of claim 19, comprising the steps of:
d. machining the core to obtain a desired shape of the core, and
e. inserting the core in a positive-locking manner between the top belt and the bottom belt such that the protecting member is formed as a monolithic cavity-free component.

21. The method of claim 19, wherein in step d. machining includes 3D-milling of the core to form tapered-off edges of the core.

22. The method of claim 19, comprising the step of:
f. manufacturing the core include a base plate and at least one reinforcement beam, which is mounted onto an upper surface of the base plate, with a length extension of the base plate arranged parallel to an edge of the protecting member.

23. The method of claim 22, comprising a further step of machining a hole through the base plate and the beam in a vertical direction of the protecting member for mounting the protecting member to the battery structure of the electric vehicle.
